(19) United States
(12) Patent Application Publication
(10) Pub. No.: US 2008/0295401 A1
(43) Pub. Date: Dec. 4, 2008

(54) Crate And Planting Pot

(76) Inventor: Guido Schmidt, Dinklage (DE)

Correspondence Address: PORTER WRIGHT MORRIS & ARTHUR, LLP;INTELLECTUAL PROPERTY GROUP, 41 SOUTH HIGH STREET, 28TH FLOOR, COLUMBUS, OH, 43215, US

(21) Appl. No.: 12/159,034

(22) PCT Filed: Dec. 8, 2006
(86) PCT No.: PCT/EP2006/011802

§ 371 Date: Aug. 13, 2008

(30) Foreign Application Priority Data
Dec. 24, 2005 (DE) 202005020177.4

(51) Int. Cl. A01G 9/02; A01G 9/04

(52) U.S. Cl. 47/71; 47/65.5

(57) ABSTRACT

A tray having at least one cavity for accommodating a plant pot during its filling, planting, or other processing in a predetermined alignment of the e.g., truncated conical plant pot that is rotationally symmetrical on the circumferential side to a center vertical axis, wherein the plant pot is located positively engaged in the cavity through base formations of the tray and of the plant pot, is designed in terms of a unique alignment of the plant pot while maintaining the high technical requirements of commercial gardening in such a way that the cavity is provided on the base side with a sliding way, which runs helically with a helical axis aligned with the vertical axis of the pot.

The invention relates to a tray according to the pre-characterizing clause of claim 1 and a plant pot according to the pre-characterizing clause of claim 9.

Trays that have cavities for accommodating plant pots are used in many cases in commercial gardening. These trays are regularly closely adapted to the plant pots and accommodate the plant pots often up to the upper edge, wherein closed intermediate surfaces form between the cavities. This permits gardening work to be simplified since the pots are fixed and because the plant soil does not fall out of the pots and the plants pots can also be accessed easily from above.

A predetermined alignment of rotationally symmetrical, preferably truncated conical plant pots is increasingly significant, if for instance the plant pot has a preferred alignment based on an imprint or a label or is supposed to have plant labels inserted at specific locations. In this case, the plant pot must be uniquely arranged in the desired alignment.

Already known are trays and plant pots with a plurality of notch locations due to associated adapted base flutings, which make sure that a plant pot inserted in a desired position in a cavity retains its alignment and does not rotate inadvertently for instance.

The objective of the invention, on the other hand, is creating a tray and a plant pot, in which the latter occupies and retains a single, uniquely predetermined alignment in a cavity, wherein, particularly in the area of the plant pot, the high requirements of commercial gardening for universal usability, ability to be irrigated and drained, inherent stiffness, and cost-effectiveness must be preserved.

According to the invention, this objective is attained with a tray according to claim 1 and with a plant pot according to claim 9. In both cases, a helical sliding way creates a rotational movement up to the alignment of the pot with respect to the cavity, which then leads into the desired predetermined and unique alignment with one another. Basically, it can suffice if the sliding way is provided only in the cavity on the base side in order to attain the desired rotating sliding movement in cooperation with any matching contact point in the base of the pot. Similarly, the plant pot alone can be provided with a helical sliding way, which interacts with a matching contact point of the cavity base and forces the desired movement. However, both the cavity and the plant pot are preferably provided with sliding ways in their bases that match each other so that a surface bearing between the two is created having the advantage of low surface stress and a low load in the base.

The sliding way can be maintained in the form a single helix over a circumferential angle of up to 360° with the advantage that the predetermined alignment is achieved as the final position with the same rotational movement clockwise or counterclockwise.

An alternative shape, which likewise produces a unique alignment of the plant pot with respect to the cavity, however, can also provide two half helixes running in opposite directions, with which the plant pot attains the desired target alignment clockwise or counterclockwise over the shortest path that is produced upon insertion.

The embodiment of the helix in the base is preferably accomplished in the form an inner dome, which produces a steep sliding way with a small helical radius, which easily leads into the desired alignment. Moreover, a base surface remains around the sliding way design in the base surface, which can be used for drainage fluting and holes.

Exemplary embodiments of the invention are depicted in the drawing and are described in more detail in the following. The drawing shows:

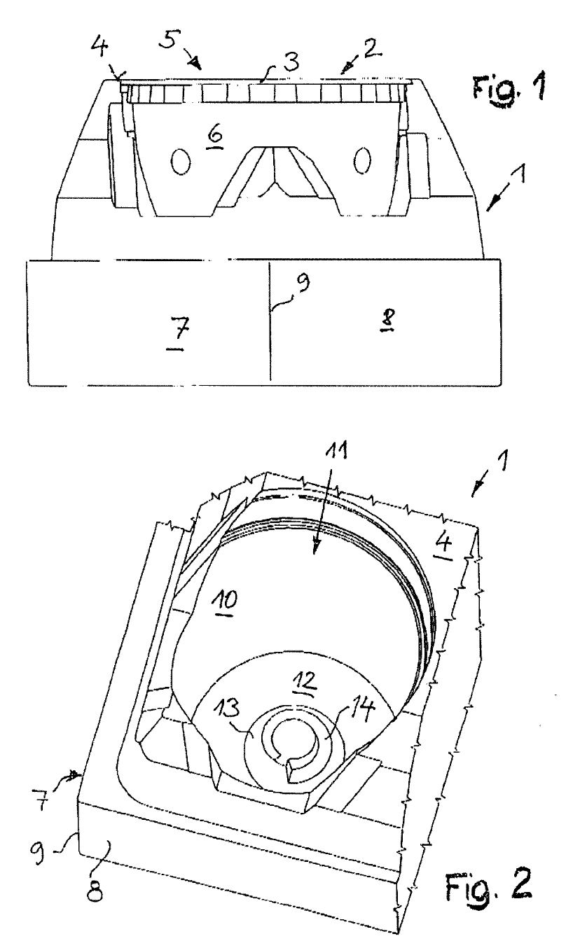

FIG. 1A tray with an inserted plant pot

FIG. 2 An oblique view from above of a portion of a tray

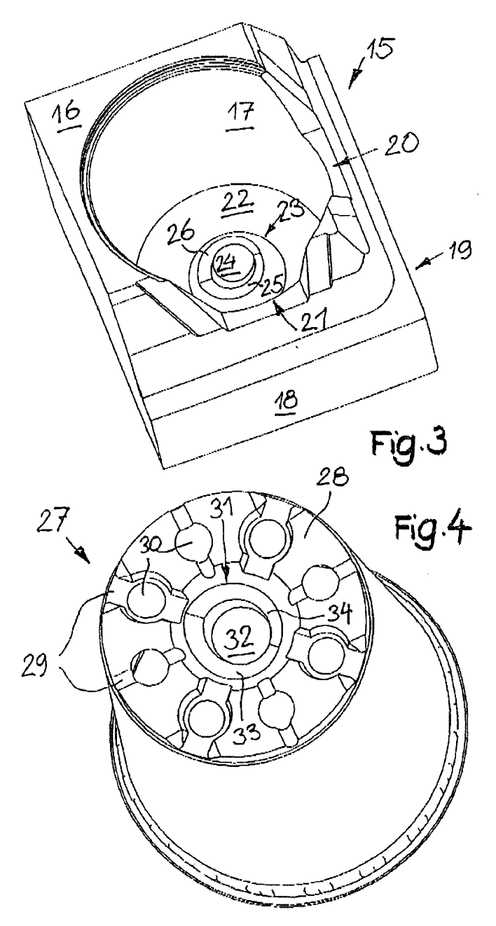

FIG. 3 An oblique view from above of a portion of another tray

FIG. 4 An oblique view of the base side of a plant pot, and

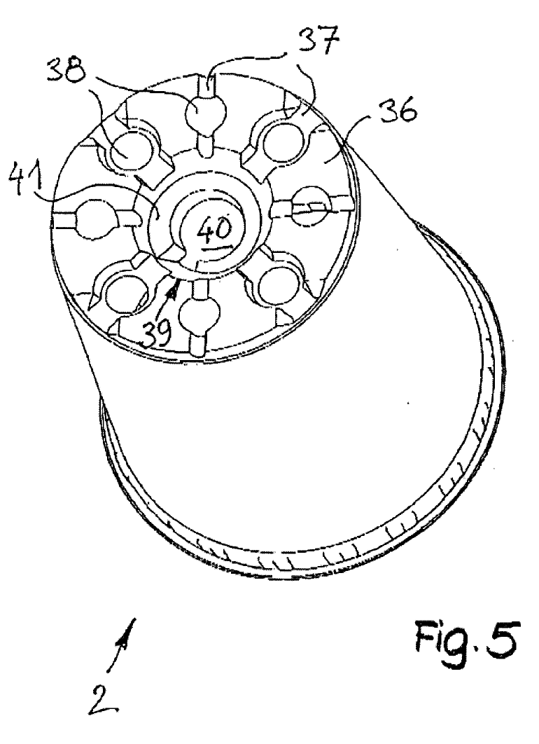

FIG. 5 An oblique view of the base side of another plant pot.

In FIG. 1 depicts a lateral view of tray 1 with an inserted plant pot 2, wherein the tray 1 accommodates the plant pot 2 with a large portion of the circumference together with a rim 3 projecting over the upper side within a work surface 4, while the plant pot, with another forward-lying area 5 of the rim and with a portion of a pot shell 6, freely sticks out on two lateral areas 7, 8 on a corner 9 of the tray.

The inserted plant pot 2 terminates flush with the work surface 4 so that when pouring in plant soil or when planting plants no soil or plant material can end up between the tray and plant pot. A work surface 4 on which soil and material can be deposited without a problem runs between the plant pots. The outer edge area of the plant pot can project toward the sides 7, 8 without being disadvantageous and can be grasped easily from the side for removal from the tray.

FIG. 2 spatially depicts an oblique view from above of the tray without a plant pot. In this case, in addition to the lateral surfaces 7 and 8, the corner edge 9 in between and the work surface 4, it shows a cavity 11, whose wall 10 is advantageously adapted closely, but with adequate movement play, to the plant pot 2 being accommodated. In the case of a truncated conical basic shape, an outer flat base 12 is formed projecting up in the center in the shape of a dome 13, on which a helix 14 is embodied, which extends over a circumferential angle of approx. 360°. The helix has a helical axis (not shown), which follows the vertical axis of the truncated conical, rotationally symmetrical cavity shape.

The cavity is provided for accommodating a plant pot, which has a formation that is sufficient to accommodate the dome 13 and which furthermore includes at least one area within this formation, which rests or slides on the helix 14 and then uses this as a sliding way so that the plant pot 2 reaches the striven for deepest position in the cavity 11 under its own weight or from a slight rotational movement applied by hand for instance. This position between the plant pot 2 and tray 1 is striven for due to its uniqueness, so that for instance plant pots with a predetermined alignment, for instance with a wrap-around label or printed image, can receive a planting related to this alignment.

FIG. 3 depicts a tray 15 with a corner part, which likewise has an upper work surface 16 and a cavity 17, which is able to accommodate a plant pot including its upper rim, which, however, on the sides 18, 19 also recedes downwards in areas 20, 21 in order to arrow the pot rim to project there and to release it. A base 22 of the cavity 17, which in turn is embodied in a flat manner on the outer side, is provided on the inside with a dome 23, which terminates on the upper side with a truncated cone 24 as a rotational and pilot pin, around which a sliding way made of two helixes running in opposite directions are embodied as sliding way parts 25, 26, each of which, after insertion of the pot, lead in the one or other rotational direction to the deepest position of the pot along the sliding way. In this case as well, the pot is provided at least with a formation accommodating the dome 23 and with at least one contact surface being provided therein, which, when positioning the pot on the sliding way of the half helixes 25 or 26 leads into the deepest position.

The pot is also preferably adapted with respect to the sliding way in terms of the surface to the corresponding sliding way of the tray 15. As FIG. 4 with an oblique view from below of a plant pot 27 shows, a base 28 terminating on the whole in an approximately flat manner on the outer region, which can also be provided in the customary manner with drainage fluting 29 and drainage holes 30, is provided, like the tray, in the center with a dome 31, which produces a sliding way with two semi-annular helixes as sliding way parts 33, 34 around the inner truncated cone 32, which sliding way can slide in terms of the surface on the sliding way of the helical parts 25, 26 of the tray 15 and thereby under slight surface pressure move the plant pot 27 into its deepest, unique work position.

Completely analogously, the plant pot 2 according to FIG. 5 is designed overall in the shape of a truncated cone with respect to a vertical axis and has a base 36, which is flat on the outer side, and drainage fluting 37 as well as drainage holes 38 therein, which reveals a dome 39 in the center, in which a sliding way 41 in the shape of a single, almost 360° helix runs around a center truncated conical pin 40. The inner annular arrangement of the helix 41 with a small radius makes a relatively steep gradient angle possible that is therefore advantageous for sliding into the desired unique position.

The material pairing between the plant pot and the tray in all previously considered cases can be expediently selected in terms of low sliding coefficients, wherein the tray in terms of the lower material expense of the working device to be used for very many plant pots is more likely to be assigned the task of ensuring the ability to slide.

The advantage of sliding ways that only have one helical direction and preferably run over a circumferential angle of 360° is that the rotational movement toward the desired alignment takes place respectively uniquely and in the same direction, and with manual assistance the same rotational direction possible. On the other hand, the advantage of sliding ways made of sliding way parts running in opposite directions, each approximately over a circumferential angle of 180°, as depicted in FIGS. 3 and 4, is a greater gradient and therefore easier, in particular automatic, sliding in.

1. Tray (1, 15) having at least one cavity (11, 17) for accommodating a plant pot (2, 27) during its filling, planting, or other processing in a predetermined alignment of the e.g., truncated conical plant pot (2, 27) that is rotationally symmetrical on the circumferential side to a center vertical axis, wherein the plant pot (2, 27) is located positively engaged in the cavity (11, 17) through base formations of the tray (1, 15) and of the plant pot (2, 27), characterized in that the cavity (11, 17) is provided on the base side with a sliding way (14, 25, 26), which runs helically with a helical axis aligned with the vertical axis of the pot (2, 27).

2. Tray according to claim 1, characterized in that the sliding way (14) is comprised of a single sliding way part running from an upper helical beginning to a helical end lying beneath.

3. Tray according to claim 1, characterized in that the sliding way is formed of two sliding way parts (25, 26) running in opposite directions, each running over approx. 180° between an upper helical beginning and a lower helical end that is opposite with respect to the vertical axis.

4. Tray according to claim 1, 2, or 3, characterized in that the sliding way (14, 25, 26) is arranged in an inner annular region of the base (12, 22).

5. Tray according to one of claims 1 through 4, characterized in that the sliding way (14, 25, 26) is embodied on a dome (13, 23) in the base (12, 22).

6. Tray according to one of claims 1 through 5, characterized in that both the plant pot (2, 27) and the cavity (11, 17) are provided with sliding ways (14, 25, 26, 33, 34, 41) that are adapted to one another in terms of their surfaces.

7. Tray according to one of claims 1 through 6, characterized in that the tray (1, 15) is comprised of plastic.

8. Tray according to claim 7, characterized in that the tray (1, 15) with the plant pot forms (2, 27) a plastic material pairing with good sliding properties.

9. Plant pot (2, 27) for accommodation in a tray (1, 15) in particular according to one of claims 1 through 8 during filling, planting, or other processing, characterized in that on the base side, the plant pot (2, 27) has a sliding way (25, 26, 41) in a helical shape running coaxially to the vertical axis of the pot (2, 27).

10. Plant pot according to claim 9, characterized in that the sliding way is formed of two sliding way parts (33, 34) running in opposite directions, each running over a circumferential angle of approx. 180°.

11. Plant pot according to claim 9, characterized in that the sliding way (41) is comprised of a single sliding way part running from a lower helical beginning to a helical end lying beneath.

12. Plant pot according to claim 9, 10, or 11, characterized in that the sliding way (33, 34, 41) is formed in the shape of a helical strip with a strip width directed radially toward the vertical axis of the pot.

13. Plant pot according to one of claims 9 through 12, characterized in that the pot is provided on the base side around a sliding way (33, 34, 41) forming a dome (31, 39) with lower-lying drainage fluting and holes (29, 30, 37, 38).

14. Pot plant according to claims 9 through 13, characterized in that it is embodied as a thin-walled plastic pot.
